(19) United States
(12) Patent Application Publication
(10) Pub. No.: US 2011/0018160 A1
(43) Pub. Date: Jan. 27, 2011

(54) Method of Producing Covers for Electronics

(76) Inventor: Frank J. ZIBERNA, Elmhurst, IL (US)

Correspondence Address: Erickson Law Group, PC, 1749 S. NAPERVILLE ROAD, SUITE 202, WHEATON, IL, 60189, US

(21) Appl. No.: 12/509,337

(22) Filed: Jul. 24, 2009

(51) Int. Cl. B28B 11/04; B28B 11/14

(52) U.S. Cl. 264/129; 264/157

(57) ABSTRACT

A process of making parts for electronics including forming a plurality of covers in a cover group where the covers are connected by interspaced portions. An electrically conductive material may be applied to the bottom side of the group for shielding electro-magnetic interference, electrostatic discharge, radio frequency interference, or other unwanted exterior disturbance, discharge, or interference. The covers are separated from the cover group.

### FIELD OF THE INVENTION

The invention relates to a method of producing covers for electronics, including covers having shielding properties. Particularly it relates to the process of making covers suitable for micro-electromechanical systems (MEMS).

### BACKGROUND OF THE INVENTION

It is well known that electronic signals within electronic packages emit electro-magnetic energy from the package, which causes electro-magnetic interference (EMI) in other electric signals. It is desired to provide a complete and efficient shielding against the emission of EMI. On the other hand, electrostatic discharge (ESD) is also another important issue because electronic components are also very sensitive to ESD and special care must be taken in handling. Radio Frequency (RF) interference can also be a problem. However, if the package is properly shielded by a conductive material, it will serve to reduce EMI, RF and ESD problems.

Also, some electronic applications do not require shielding but do require covering. Moreover, some applications require covering to form a sealed chamber for the electronic device to prevent contamination. Some applications require a covering to also providing shielding.

Micro-Electro-Mechanical Systems (MEMS) involves the integration of mechanical elements, sensors, actuators, and/or electronics on a common silicon substrate through microfabrication technology. Micromechanical components may be fabricated using micromachining processes that selectively etch away parts of the silicon wafer or add new structural layers to form the mechanical and electromechanical devices. MEMS components may also be fabricated by using other micro-electronic techniques, such as disclosed in U.S. Pat. No. 6,861,277, which is incorporated by reference. The MEMS size factor enables MEMS system to occupy a smaller area. MEMS devices range in size from the sub micrometer (or sub micron) size to the millimeter size.

Covers maybe made out of a number of materials including metal and plastic. However, the inventor recognizes that plastic may be preferred due, for example, to manufacturing efficiencies obtained when producing large volumes of small covers. The inventor recognizes that plastic may also be preferred as it become difficult to shape metal covers at small form factors including small MEMS form factors.

As technologies emerge providing electronics in an increasingly smaller form factor the inventor recognizes a need for shielding of a corresponding smaller size. The inventor recognizes a need for a manufacturing process for such shielding that is efficient and able to accommodate shield of smaller sizes. The present inventor recognizes that it would be desirable to have a process of making small plastic covers.

### SUMMARY OF THE INVENTION

The invention comprises a process of making parts for electronics. The process includes forming cover groups having a plurality of covers where the covers are connected by interspaced portions. Then, the covers are separated from the group in a separating step.

In one embodiment, an electrically conductive material is applied to one side of the group after the group is formed and before it is separated.

In one embodiment, the electrically conductive material is applied to the inside surface of the cover.

In one embodiment, the step of forming is further defined in that each cover has a maximum dimension of 21 millimeters, where the dimension is defined by the furthest distance between two points on the external surface of the cover.

In one embodiment, the step of forming is further defined in that each cover has a minimum dimension of 0.1 millimeters, where the dimension is defined by the furthest distance between two points on the external surface of the cover.

In one embodiment, the step of separating comprises the step of separating the covers from the group over packaging so that each separated cover lands in a predefined location in the packaging.

In one embodiment, the step of separating is further defined in that it comprises the step of taking a least one of the covers from the packaging and placing it on or over one or more electronic components.

In one embodiment, the step of taking is defined in that a robot takes one of the covers from the packaging and places the cover over one or more electronic components.

In one embodiment, the electrically conductive material is applied by vapor deposition.

In one embodiment, the electrically conductive material is applied by plating.

In one embodiment, the cover is sealed over one or more electronic components.

In one embodiment, the step of separating includes the step of separating all of the covers substantially simultaneously from the interspaced portions.

In one embodiment, the step of forming is further defined in that the covers are formed spaced apart a first distance in rows. The step of separating comprises the steps of providing a tape pocket packaging with pockets spaced apart a second distance in a row so that when the covers are separated from the interspaced areas using a separating tool the covers will be aligned with and received by the pockets.

Numerous other advantages and features of the present invention will become readily apparent from the following detailed description of the invention and the embodiments thereof, and from the accompanying drawings.

### BRIEF DESCRIPTION OF THE DRAWINGS

FIG. 1 is a bottom view of a mold group;

FIG. 2 is a bottom view of interspaced portions of the cover group with covers removed;

FIG. 3 is a bottom view of the covers after removal from the mold group;

FIG. 4 is a bottom view of a cover;

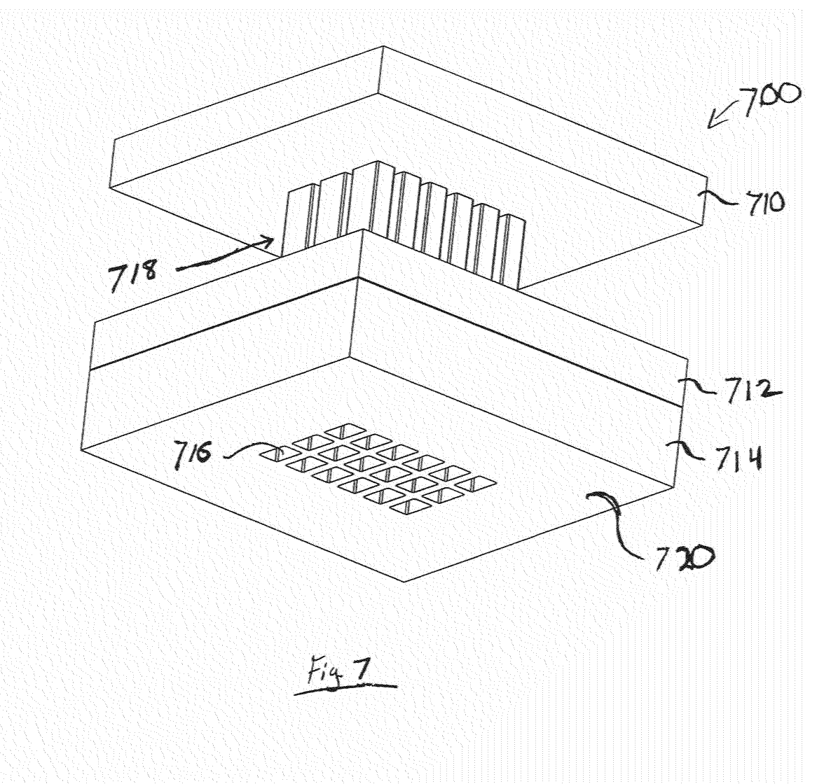

FIG. 5 is a bottom perspective view of the mold group; and

FIG. 6 is a bottom perspective view of a cover.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

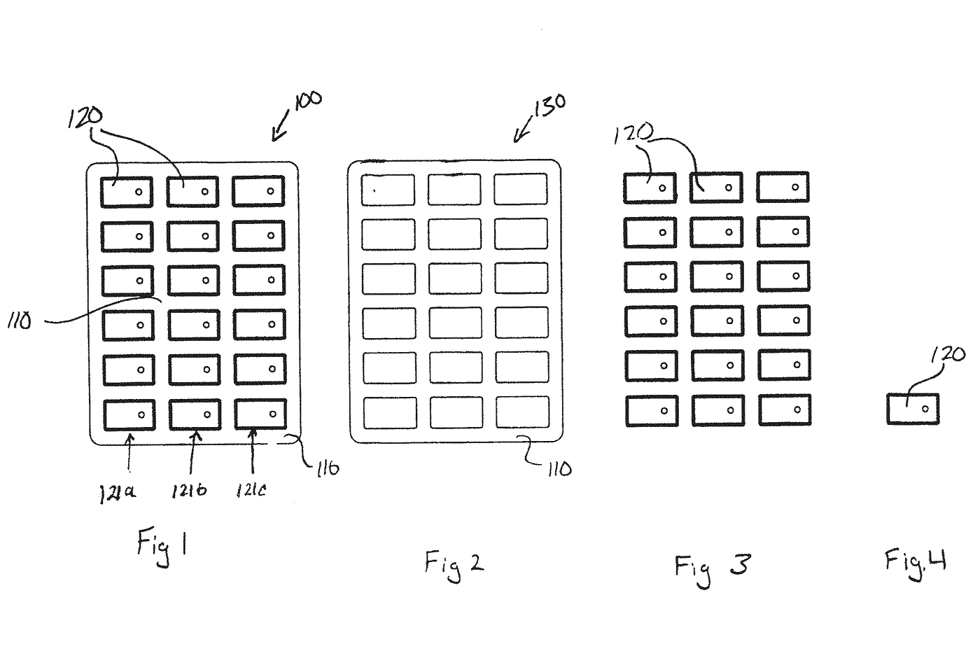

FIG. 1 shows a mold group or nest 100. In one embodiment, the group 100 is composed of plastic. The mold group 100 has a plurality of covers 120 formed in the plastic. In one embodiment covers are configured to block electronics from external substances or debris. The covers may be configured to form a sealed chamber over an electronic device or electronic component to prevent contamination from external substances or debris. In one embodiment, the covers 120 comprise shields having shielding properties for blocking or reducing electro-magnetic interference, electrostatic discharge, radio frequency interference, or other unwanted exterior disturbance, discharge, or interference. The interspaced portions 110 of the group consist of the areas between and/or around the covers 120. The group may comprise rows 121a, 121b, 121c of covers 120. The interspaced portions 110 are of the same material as the covers 120. The interspaced portions 110 connect the covers. The interspaced portion and the covers can be formed as a unitary part. The group has a bottom side 112 and a top side (not shown). The covers extend from the bottom side 112. In one embodiment, the top may comprise a metal insert taking the place of a full plastic top.

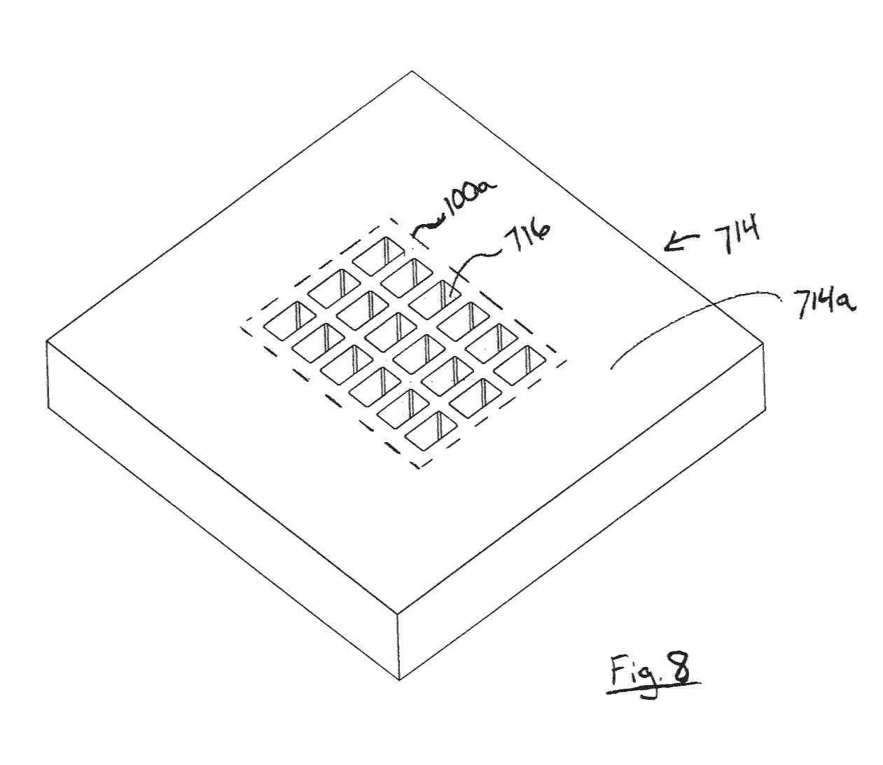

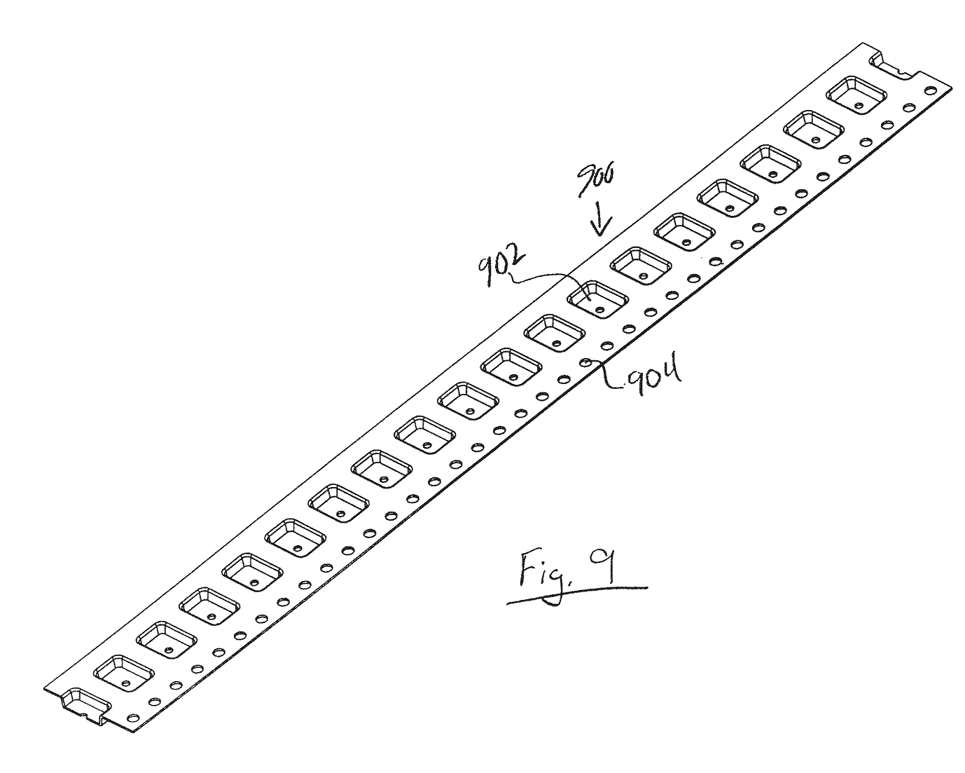

FIG. 5. provides a perspective view of the group 100. FIG. 6 shows an enlarged perspective bottom orientated view of the cover 120. The cover 120 has four inner side walls 124 and four outer sidewalls 122. The cover has an inner floor 128 connected to the side walls to form a three dimensional shape, which may be square or rectangular in shape. However, the cover is not limited to square or rectangular shapes but include other non-four sided shapes. The side walls have a bottom edge 129 opposite the inner floor 128.

The group may be formed by any manner of forming parts, including plastic parts. In one embodiment, the group 110 is formed by an injection molding process. In another embodiment, the covers 120 have a hole 128a in the inner floor, however a process producing covers without holes is within the scope of the invention.

In one embodiment, the group 110 is formed with an opening 128c in the inner floor 128, as shown by dashed lines in FIG. 6. A metal insert 128e is then placed in the opening 128c to close the opening and is sealably secured to the sidewalls or the remaining portions 128f of the inner floor.

After the group 100 is molded, the electrically conductive material is applied to the bottom 112 side of the group 110. The electrically conductive material may include tin, silver, nickel, titanium and gold, however other electrically conductive material may also be used. In one embodiment, the material is applied using a rack coat process. The rack coat process includes connecting parts to a rack and then submerging the rack including the parts in the electrically conductive material solution. The parts may be connected to the rack by, for example, wire or ties. In one embodiment, the group is coated by plating, for example, plating by sputter deposition or vapor deposition. Vapor deposition includes a vacuum deposition to deposit thin films by the condensation of a vaporized form of the material onto the group. The electrically conductive material is applied such that the inner floor 128 and the bottom edge 129 are coated. In one embodiment, all the inner side walls 124 are also covered by the electrically conductive material. The top side (not shown) of the group 110 is not coated. The top side is on the opposite side as the inner floor 128. This allows the coating of the all of the covers 120 within the group 110 at one time. This has the advantage of reducing coating and handling costs.

Next, the group 100 is placed in a trim or separating tool and the individual covers 120 are separated from the interspaced portions 110. The trim tool may, for example, be a cutting tool or a metal blade punch. A punch 700 is shown in FIG. 7. The punch 700 has a pad 710 guiding a plurality of punch members 718. The punch 700 also has a die block 714 and a stripper plate 712. The block 714 and the stripper plate 712 both have punch holes 716.

The group is placed on the block 714 with the bottom side 112 down toward the block top 714a, as shown by the group position outline 100a in FIG. 8. The stripper plate is placed over the group and the block 714. Then the punch members 718 are driven down through the punch holes 716 of the stripper plate. The punch members contact the covers and separate the covers 120 from the interspaced portions 110 as the punch enters the punch holes 716 of the block. Then the covers, being separated from the interspaced portions, either fall out of the bottom 720 of the block 716 or the covers are driven out of the bottom 720 by the punch members 718.

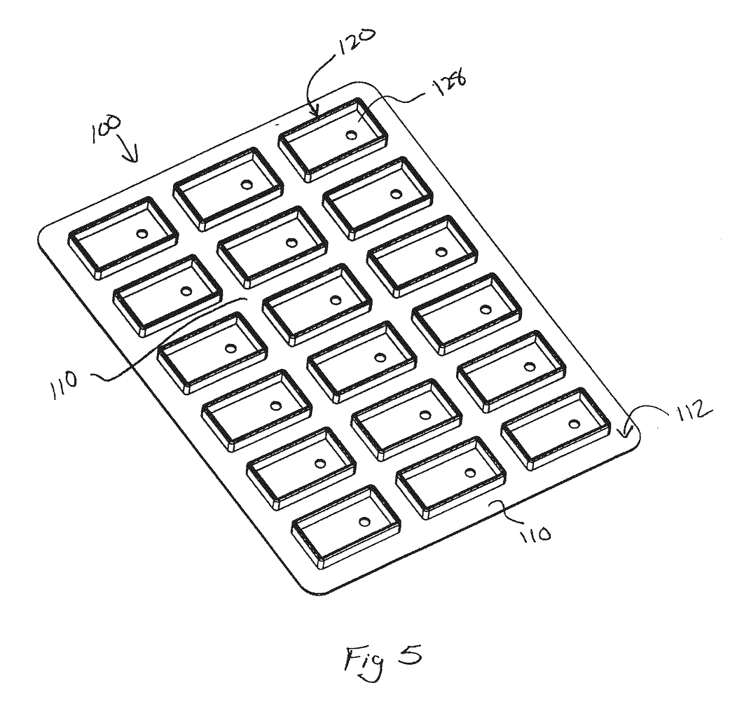

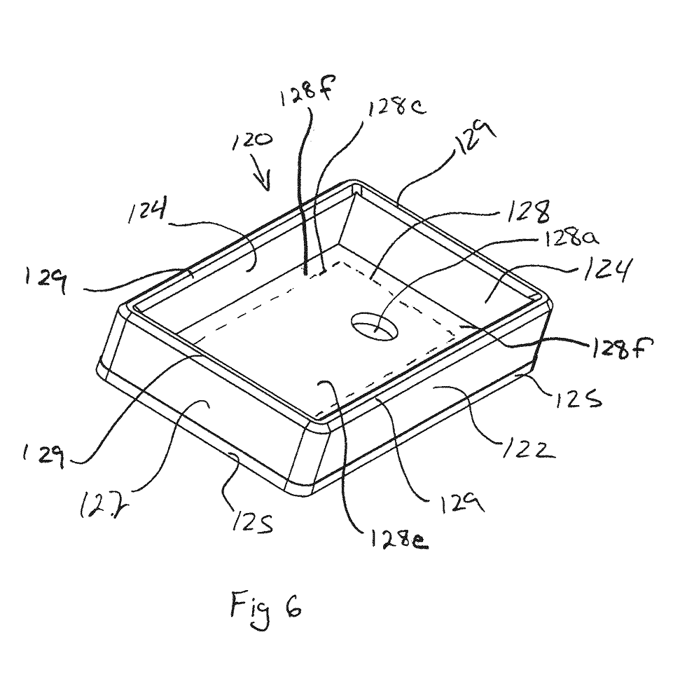

FIG. 2 shows the connected interspaced portions 130 after the covers 120 are removed by the separating tool. FIG. 3 shows the cover 120 after being removed from the interspaced portions 110, 130.

In one embodiment, the covers are separated from the interspaced portions leaving a rim 125, as shown in FIG. 6, that extends away from the outer wall 122. The rim may extend, for example, 0.05 micrometers out from the outer wall 122.

Tape pocket packaging 900 is shown in FIG. 9. The tape pocket has a number of pockets 902 aligned in a series one after another. The packaging can be placed in a machine that engages the tractor holes 904 to advance the packaging before and after the packaging is filled with covers.

In one embodiment, the pockets 902 are spaced apart in the tape pocket packaging 900 a first distance. The covers are spaced apart in the direction of rows 121a, 121b, 121c in the group at second distance. The first and second distances are equal so that covers may be separated from the interspaced portions and directed into the pockets 902.

In one embodiment, the covers 120 are separated from the interspaced areas one row at a time, as for example by separating the first row 121a, then separating the second row 121b, and then separating the third row 121c. The tape packet packaging is placed below the separating tool so that the first row 121a of covers fall into a corresponding empty group of packets 902. Then the tape pocket packaging is advanced by a device engaging the tractor holes 904, so that a new group of empty pockets is located below the next row, for example row 121b, that is to be separated from the interspaced areas. The separating tool then separates the next row, for example 121b, so that the covers fall into the new group of empty tape pocket packaging.

In one embodiment, the covers 120 are formed as a group with the same spacing between the covers as the packaging in which the covers will be placed. The tape pockets are located below the group when the trim tool separates the covers from the interspaced portions. The covers then fall directly into the tape for further transport and packaging.

In one embodiment, the covers are formed in the cover group spaced apart from each other with the same spacing required for packaging the covers and thereby handling is reduced. The packaging holds the covers in place. A robot picks up one or more covers from the packaging and places them over or on the electronic components to be covered and/or shielded. In one embodiment, the robot may be a pick-and-place type of robot. These components may, for example, be on a circuit board. The packaging may be moved by a machine, such as a conveyor, to a robot station where the robot moves the covers from the packaging to the items to be covered or shielded, such as electronic components and circuit boards.

In one embodiment, the size of each cover is in the range of 0.5 millimeters (mm) wide by 0.5 mm long by 0.2 mm deep to 15 mm wide by 15 mm long by 5 mm deep. All the covers in a cover group may be the same size or one or more covers in the cover group may be of different sizes.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A process of making covers for electronics, comprising the steps of:
forming a cover group having a plurality of covers where the covers are connected by interspaced portions; and
separating the covers from the group.

2. The process of claim 1, comprising the step of, after the forming step and before the separating step, applying an electrically conductive material to the one side of the group.

3. The process of claim 2, wherein the step of applying is further defined in that the electrically conductive material is applied to the inside surface of the cover.

4. The process of claim 3, wherein the step of forming is further defined in that each cover has a maximum dimension of 21 millimeters, where the dimension is defined by the furthest distance between two points on the external surface of the cover.

5. The process of claim 3, wherein the step of forming is further defined in that each cover has a minimum dimension of 0.1 millimeters, where the dimension is defined by the furthest distance between two points on the external surface of the cover

6. The process of claim 1, wherein the step of separating comprises the step of separating the covers from the group over packaging so that each separated cover lands in a predefined location in the packaging.

7. The process of claim 6, further comprising the step of taking at least one of the covers from the packaging and placing it on or over one or more electronic components.

8. The process of claim 7, wherein the step of taking is further defined in that a robot takes one of the covers from the packaging and places the cover over one or more electronic components.

9. The process of claim 2, wherein the step of applying is further defined in that the electrically conductive material is applied by vapor deposition.

10. The process of claim 2, wherein the step of applying is further defined in that the electrically conductive material is applied by plating.

11. The process of claim 1, further comprising the step of sealing a cover over one or more electronic components.

12. The process of claim 1, wherein the step of separating comprises the step of separating all of the cover substantially simultaneously from the interspaced portions.

13. The process of claim 1, wherein the step of forming is further defined in that the covers are formed spaced apart a first distance in rows; and
wherein the step of separating comprises the steps of
providing a tape pocket packaging with pockets spaced apart a second distance in a row so that when the covers are separated from the interspaced areas using a separating tool the covers will be aligned with the pockets and received therein;
directing the separated covers to corresponding pockets using the separating tool.

14. A process of making covers for electronics, comprising the steps of:
forming a plurality of covers in a cover group where the covers are connected by interspaced portions;
applying an electrically conductive material to the one side of the group; and
separating the covers from the group.

15. The process of claim 14, wherein the step of forming comprises the step of forming a plurality of covers each having an inner floor opposite an open side and surrounded by sidewalls, the inner floor at least partially occupies the geometric plane formed by the interspaced portions; and
the step of applying is further defined in that the electrically conductive material is applied to the inner floor of the covers.

16. The process of claim 14, wherein the step of separating comprises the step of separating the covers from the group over packaging so that each separated cover lands within its predefined location in the packaging.

17. The process of claim 16, comprising the step of taking at least one of the covers from the packaging and placing the at least one of the covers on a MEMS device.

18. The process of claim 14, wherein the step of forming comprises the step of:
forming a plurality of covers each having an inner floor, the inner floor having an open area; and,
placing an insert over the open area.

19. The process of claim 14, wherein the step of separating comprises the step of directing the separated covers to predefined locations in a packaging using a separating tool.

20. A process of making parts for electronics, comprising the steps of:
forming a plurality of parts in a group where the parts are connected by interspaced portions;
applying an electrically conductive material to the bottom side of the group; and
separating the parts from the group.
